(19) United States
(12) Patent Application Publication
(10) Pub. No.: US 2006/0267976 A1
(43) Pub. Date: Nov. 30, 2006

(54) Three-Dimensional Image Processing System Rendering Images by Partially Decompressing Compressed Image Data Set

(75) Inventors: Motoaki Saito, Tokyo (JP); Kazuo Takahashi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: TERARECON, INC., San Mateo, CA (US)

(21) Appl. No.: 11/383,930

(22) Filed: May 17, 2006

(30) Foreign Application Priority Data
May 31, 2005 (JP) 2005-185651

(51) Int. Cl. G06T 15/00

(52) U.S. Cl. 345/419

(57) ABSTRACT

A method of three-dimensional image processing includes storing a set of compressed image data in a memory, the image data usable for creating three-dimensional images, identifying and decoding portions of the set of compressed image data stored in the memory based on requests sequentially issued by an image processing engine according to a progress of image processing, and providing the decoded portions of the set of compressed image data to the image processing engine.

### FIELD OF THE INVENTION

This invention relates to a three-dimensional display device that creates three-dimensional images, while sequential partial decompression is applied according to the progress of the processing of three-dimensional data containing compressed image data.

### BACKGROUND

X-ray computed tomography (CT) devices are used to collect projection data from horizontal profiles of a patient when the intensity of X-rays passing through a patient is detected with an X-ray detector while a patient who is lying on the side is being irradiated from an X-ray tube, moving around the periphery of a plate attached to a bed. Because the strength of the X-rays passing through the patient is detected by the detector, projection data can be collected from the vertical profile of the patient. Next, after the plate attached to the bed has been moved, projection data is again collected in the same manner from the profile of the patient. Projection data can be therefore collected for a plurality of lateral profiles of the patent with repeated operations when the plate is moved and the projection data is thus collected. When image reconstruction operations are then conducted which correspond to data collected in this manner from multiple profiles of the patient, image data can be collected which corresponds to multiple lateral profiles of a patient.

While during the early days, X-ray CT devices were used so that projection data was alternately collected while a patient was irradiated with X-rays so that a plate was moved while the patient was lying on the side, the latest type of X-ray CT devices can be used so that projection data is collected while X-ray irradiation is carried out simultaneously with the movement of a plate when the patient is lying on the side. The method used to collect data in this manner is called the helical scan method.

Because with the initial X-ray CT devices, the intensity of X-rays passing through a patient was detected with one array of detectors, arranged along the axial direction of the body of the patient, projection data was collected from the horizontal profile of the patient. As the technology of X-ray CT devices was rapidly developing, multiple arrays of detectors were used arranged in an X-ray detector in the direction of the body of the patient with the latest X-ray CT devices so that projection data could be colleted from multiple profiles of the patient. This method for detection using at the same time multiple arrays of detectors, which has become known as the helical method, has made it possible to collect a much greater amount of projection data than what was possible with the initial X-ray CT devices. Regardless of whether the collection profile of the data existed, such as discrete data that was collected in the initial period with X-ray CT devices with a multiple array detector using the helical scan method, projection data is determined on a virtual horizontal profile so that interpolation processing is performed to projection data as a virtual horizontal profile is generally set and image reconstruction processing operations were conducted using the projection data of these virtual profiles. Since it is possible to set these virtual profiles freely, it is also possible to freely select the intervals between horizontal profiles and the number of pages with image data that can be obtained with image reconstruction processing operations set sequentially for virtual horizontal profiles.

When the latest CT devices using multiple arrays of detectors with the helical scan method are compared to the X-ray CT devices of the early days, since the noise of X-ray detectors has been decreased while the space density of X-ray scanners has been increased, and the helical scan pitch density has been also increased, this makes it possible to collect projection data with a clear detail in the axial direction of the body of the horizontal profile of the patient.

This, therefore, made it possible to obtain sharp images with little noise, even if spatial region was reduced when image reconstruction operations were performed. Accordingly, the spatial resolution was improved in the image in the region of interest on the body of the patient by reducing the image reconstruction region. In addition, since it is also possible to obtain meaningful images with little noise even with a narrow thickness of the image reconstruction plane, the interval between the image reconstruction plants can be also made narrower during image reconstruction and the number of image pages for image reconstruction can be increased, making it possible to improve the spatial resolution in the axial direction of the body.

With X-ray CT devices, the precision of scanning in the direction of the body was increased thanks to the popularity of X-ray CT device devices using the latest multiple array scanners, and the high density design of the spacing in recreated images which accompanied this increased precision made it possible to create image data with fine intervals between the slices. This was in turn accompanied by a great increase in the number of the pages of image data created with one scan. Similarly, also in the field of magnetic resonance (MR) devices, the number of pages of MR image data created with one scan was greatly increased when compared to the devices used during the initial period. In the past, image data created with one scan was printed onto a film and imaging was then performed when this film was observed. However, when a great number of image data pages are created with one scan, it is difficult to observe all of these images on a film. Therefore, three-dimensional images are created from image data, which are obtained even with routine imaging, and these images are then observed. With three-dimensional image display devices using this X-ray CT image data, voxel data is created with superimposition in the axial direction of the body of image data of the lateral profile of the patient, and three-dimensional images are obtained when this data is used to perform three-dimensional reconstruction processing operations. When X-ray CT image data is used which has been obtained with a X-ray CT device according to the helical scan method with the latest design of multiple array detectors, sharp three-dimensional images can be obtained with a high spatial resolution.

When three-dimensional images are prepared from CT image data, the image data of a lateral profile of a patient is superimposed in the axial direction of the body to create volume data. If the number of picture elements in a horizontal profile is, for example, 512×512 pixels in image data corresponding to 0.5 mm×0.5 mm in the axial direction of the body, using 512 pages for example with an interval of 0.5 mm, an empty area corresponding to 256 mm×256 mm×256 mm creates a cubic structure of 2 voxels with 512×512×512 individual elements. Next, surface rendering and volume rendering is applied to this cubic structure comprising voxels when three-dimensional reconstruction processing operations are performed to create a three-dimensional image. In this case, memory enabling to hold 256 MB of data is required to handle 16 bit data comprising 512×512×512 individual elements.

When image data having image element dimensions of 1.0 mm×1.0 mm with 512×512 pixels is superimposed in the axial direction of the body with an interval of 1.0 mm, a cube constructed of 512×512×1,024 individual voxels is obtained having spatial regions corresponding to 512×512×1,024 mm. Next, a three-dimensional image is created when three-dimensional reconstruction processing operations are applied with volume rendering and surface rendering to the cube constructed of these voxels.

In this case, memory capable of holding 512 MB of loaded data will be required in order to handle 512×512×1,024 of individual elements of 16-bit data. In addition, the latest image data technology uses image data with 1,024×1,024 pixels and with image element dimensions of 0.4 mm×0.4 mm, creating 2,000 pages with an interval of 0.4 mm in the axial direction of the body, or 4,000 pages when image reconstruction processing operations are conducted. When three-dimensional images are then created with this image data, image memory of 4 GB will be required in order to handle 16-bit data comprising 1,025×1,024×4,096 individual image elements.

Also cardiological (“cardio”) image data of a patient can be collected simultaneously with an electrocardiogram. For example, when one heart beat is divided into 10 equal parts with 1/10 heart beat intervals, image data can be divided into 10 phase categories of such imaging data. When the imaging data in each phase is then used to create image data for 10 phases with image reconstruction processing, three-dimensional images can be created with 10 phases. If the horizontal profile per each phase holds image data with the image element dimensions of 0.5 mm×0.5 mm using for example 512×512 pixels per a horizontal profile in one phase and the image data is superimposed in the axial direction of the body with an interval of 0.5 mm so that 512 pages are superimposed, a cube will be created with 512×512×512 individual pixels having spatial regions corresponding to 256 mm×256 mm×256 mm. Next, three-dimensional images are created by applying three-dimensional restructuring operations such as volume rendering to this cube volume data constructed with these image elements. Because 16-bit data will be handled with 512×512×512 individual elements per one phase, a memory enabling to load 256 MB of data will be required. With data corresponding to 10 phases, 256 MB/phase×10 phases=2.5 GB will be created. Therefore, in order to display three-dimensional cardio images using 10 phases with 256 MB of data per one phase, a memory capable of holding 2.5 GB of data will be required.

Three-dimensional image display devices which have been commonly used in the past will be explained next. FIG. 4 is a block diagram showing a conventional three-dimensional image display device. In FIG. 4, reference numeral 401 is an X-ray CT device, such as an MR device or a similar example of an image diagnosis device; reference numeral 402 is a picture archiving and communication system (PACS) server indicated as an example of an image data storage system; reference numeral 403 indicates an example of an internal network inside a hospital, etc.; reference numeral 411 indicates a three-dimensional image display device; reference numeral 412 indicates a network interface.

A network interface 412, connected to an internal hospital network 403, together with an X-ray CT device 401, an MR device and the like, receives image data 511 from the PACS server 402, etc. When image data 512 is received, the image data 512 is in some cases maintained as uncompressed data, or it can be stored using an irreversible compression method or a reversible compression method such as JPEG2000.

Image data 512 is stored in an image data storage (e.g., a magnetic disk) 413. Reference numeral 415 is a processing part for three-dimensional images, reference numeral 416 is image memory for processing of three-dimensional images, and reference numeral 418 is a three-dimensional image processing engine. The image memory 416 for processing of three-dimensional images holds uncompressed image data which is used to create three-dimensional images.

The three-dimensional image processing engine 418 sends a command 553 requesting the image memory 416 to supply voxel data 517 for three-dimensional image processing by specifying voxel coordinates sequentially. The image memory for three-dimensional image processing 416 supplies requested voxel data 517 to the three dimensional image processing engine 418. The three-dimensional image processing engine 418 executes three dimensional image processing using the voxel data 517 supplied by the image memory 416. By repeating the processes of (1) voxel data request 553 from the three dimensional image processing engine 418 to the image memory 416, (2) supplying voxel data 517 by the image memory 416 to the three dimensional image processing engine 418, and (3) three-dimensional image processing of the voxel data 517 by the three dimensional image processing engine 418, three dimensional image 518 is generated.

Reference numeral 551 indicates that an instruction has been obtained from a console specifying image data to be used to create a three-dimensional image. According to this instruction, the device stores image data 414 or decompressed image data from compressed image data, which is read from image data storage 413, in three-dimensional image processing memory 416.

Reference numeral 552 indicates an instruction obtained from a console relating to image parameters for processing of three-dimensional images used in order to create a three-dimensional image. When the three-dimensional image processing device 418 obtains DICOM information, etc., from the image data read from the three-dimensional image processing memory 416, processing of three-dimensional images is begun with three-dimensional image processing parameters and indicated these obtained parameters.

In order to handle 16-bit data with 512×512×512 individual elements with the conventional three-dimensional image display device described here, a memory capable of loading 256 MB of data is required. In order to display three-dimensional cardio images using 10 phases with 16-bit data for individual 512×512×512 elements per one phase, image memory enabling to load 2.5 GB of data will be required. Handling of such a large amount of image data with a three-dimensional image display device according to prior art caused problems with the storage of this large amount of data, as well as other problems related to the fact that a large-capacity magnetic disk was required, and it was also not possible to ignore the fact that a long time was required to transfer a large volume of image data from the magnetic disk to the image memory.

In the case when image data has been compressed as reversibly compressed images, the data amount can be generally compressed to the range of ½˜⅓. As was mentioned above, when image data having 512×512 image elements per a horizontal profile is superimposed with 1,024 pages in the axial direction of the body, image memory which makes it possible to load 512 MB of data will be required to handle 16 bit data with 512×512×1,024 individual elements. Assuming that the data can be compressed with reversible compression to ⅓, the specified amount can be compressed in image memory as 512 MB (⅓)=170 MB.

Also, when projection data corresponding to 10 phases of projection data is divided into categories according to 1/10 heart beat intervals having 10 equal portions, 10 phase portions are used with 512 pages of image data containing 512×521 image elements per phase in images reconstructed in this manner.

Considering a case when three-dimensional images are created with 10 phases, 256 MB is required to handle 16 bit data with 512×512×512 individual elements per 1 phase, and 2.5 GB of date will be required for loading the data to image memory with 10 phases. Assuming that the data amount can be compressed with reversible compression to ⅓, the amount needed for image memory can be compressed to 2.5 GB×(⅓)=835 MB.

Although an example of reversibly compressed image data was explained here, sufficiently realistic three-dimensional images can be also created with irreversible compression. When irreversible compression is used, the amount of memory needed as image memory can be further decreased by a considerable amount.

It was explained up until now on one example of an X-ray CT device that the number of pages was increased with image reconstruction processing and with a high density design applied to the intervals between the image reconstruction planes of the data amount collected as X-ray CT image data with one scan, so that compression of image data becomes unavoidable when a geometrically progressive increase is created, while a similar increase of the data amount of MR image data is also created when data is collected with one scan, compared to the MR devices which was used initially. Due to the data amount which is generated by medical image diagnostic devices and used in image data, compression of image data becomes unavoidable. The storage of the amount of the image data on magnetic disk is problematic even in a case when wafers for processing of three-dimensional processing are used with three-dimensional image processing. Another problem is that an explicit system needs to be applied at the same time also to the time period required for transmission of a large amount of data to the memory in the hardware substrate used for processing of three-dimensional images.

In order so solve these problems, it has been proposed that image data be compressed with reversible compression and stored in a magnetic disk, so that compressed image data or uncompressed image data is transmitted to image memory in the substrate of hardware which is used for processing of three-dimensional images at the point when three-dimensional image are created, so that decoding is then performed according to the processing of three-dimensional images in the hardware substrate used for processing of three-dimensional images. This makes it possible to transmit images with a high speed design. However, yet another problem related to hardware base plate used for processing of three-dimensional images is that restrictions are imposed on the image memory of hardware substrate used for processing of three-dimensional images. This can be also resolved so that compressed or uncompressed image data located in the hardware substrate used for processing of three-dimensional images can be sequentially decoded in parts corresponding to the processing of three-dimensional images, which makes it possible to ameliorate this restriction.

### SUMMARY OF THE INVENTION

The present invention includes a method and a related apparatus for three-dimensional image processing. The method includes storing a set of encoded image data in a memory, the image data usable for creating three-dimensional images, identifying and decoding portions of the set of encoded image data stored in the memory based on requests sequentially issued by an image processing engine according to a progress of image processing, and providing the decoded portions of the set of encoded image data to the image processing engine.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 is a block diagram explaining an embodiment of this invention;

FIG. 2 is a flowchart explaining an embodiment of this invention;

FIG. 3 is a flowchart explaining another embodiment of this invention; and

FIG. 4 is a block diagram explaining a three-dimensional image display device according to prior art.

### DETAILED DESCRIPTION

In order to reduce the specified amount of memory for creation of three-dimensional images, this invention includes a method enabling creation of reversibly compressed or irreversibly compressed three-dimensional images directly from image data.

According to this invention, an engine for processing of three-dimensional images is provided, wherein the processing engine is used for decompressing of compressed data loaded in a hardware substrate used for processing of three-dimensional images, and compressed data present in the image memory is sequentially partially decompressed according to the requests of the engine for processing of three-dimensional images along with the processing of the three-dimensional image processing operations. In a case using volume rendering as one example of processing of three-dimensional images, an engine for processing of three-dimensional images is provided which sequentially decompresses compressed data in minimum units of compressed data present in image memory according to the requests of a three-dimensional image processing engine, so that volume rendering operations are performed while this data is used by this engine for processing of three-dimensional images. During accumulation and calculations, decoding processing is not necessary for sub-volume processing when volume processing is performed with zero voxel skip processing so that empty or transparent voxels are skipped with an optimized design for early ray termination. This makes it possible to alleviate the requirements placed upon the capability for decoding processing operations.

This enables a very economical use of the memory used for processing of three-dimensional images when the processing of volume rendering operations is performed, as well as development of a volume of data corresponding to several multiples with the same memory capacity.

Since due to the optimized terminating design of early ray termination for unnecessary accumulation calculations which are in progress, with zero voxel skip processing for skipping of empty or transparent voxels, it is not necessary to perform decoding of all of the volume data, it is usually sufficient when decoding processing operations are applied to only about 3˜15%. This makes it possible to alleviate the requirements placed upon the decoding processing capability, which in turns makes it possible to minimize the requirements placed upon the hardware that is needed for decoding.

Task to be Achieved by this Invention

Technological progress in the area of the latest medical image diagnosis devices has been accompanied by a dramatic and rapid increase of the data amount represented by medical image data which can be obtained with one scan. For example, with the latest type of an X-ray CT scan device which is commonly used as an X-ray CT device having multiple arrays of detectors, the precision of scanning in the axial direction of the body has been improved so that data can be created with fine slice intervals. This has been again accompanied by a great increase in the number of the pages of image data that can be created with one scan. In the past, image data created with one scan was usually either burnt onto a film or displayed on an image display device when imaging was conducted. However, as the number of image data pages created with one scan was greatly increased, it became difficult to observe all of the image data on a film or on an image display device. That is why three-dimensional images were created from the image data obtained from scanning and these images were then observed. In order to shorten the time required for image processing operations when three-dimensional images were created with a large amount of image data, a three-dimensional image processing substrate was used in some cases, which was equipped with special hardware in the form of a built-in hardware engine for processing of three-dimensional images.

Generally, to create a high-speed design of three-dimensional image processing on this substrate that was used for processing of three-dimensional images, the substrate was provided with a specialized hardware engine for processing of three-dimensional images, and with a built-in memory for processing of three-dimensional images capable of holding image data used to created these three-dimensional images. But also in the case when three-dimensional image processing was conducted using hardware designed for processing of three-dimensional image processing operations, in addition to the problem represented by the storage capability of a hard disk in which a large amount of image data was stored, there was still the problem of an explicit or actualized system that would be also applicable to the time period during which a large amount of image data is transmitted to image memory in a hardware substrate used for processing of three-dimensional images. Another major problem, also related to the hardware substrate for processing of three-dimensional images, was represented by restrictions imposed upon the image memory in the hardware substrate for processing of three-dimensional images. The number of the pages of image data that could be handled during processing of three-dimensional images was therefore determined by the capacity of the memory in the hardware substrate for processing of three-dimensional images.

According to this invention, a three-dimensional image data display device has been proposed, which creates three-dimensional images while images are compressed and sequential partial decoding is applied according to the progress of the three-dimensional processing of images containing compressed data, corresponding to the capacity of a magnetic disk, necessitated by a major increase of medical image data and corresponding to the task relating to the capacity of memory for processing of three-dimensional images, and corresponding also to the transmission time for transmission to memory for processing of three-dimensional images from a magnetic disk.

### EXPLANATION OF REFERENCE NUMERALS

101 X-ray CT device, MR device or a similar image diagnosis device
102 PACS server, etc.
103 internal hospital network, etc.
111 three-dimensional image display device of the present invention
112 network interface
113 data compression processing capability
114 magnetic disk
115 three-dimensional image processing part of the present invention
116 compressed image memory for three-dimensional image processing
117 engine for decoding (decompressing) of compressed image data
118 engine for processing of three-dimensional images
119 image display device
211 image data sent by an X-ray CT device, MR device, PACS server or the like
212 received image data
213 compressed image data compressed with data compression processing function
214 compressed image data transmitted from a magnetic disk to a compressed image memory for three dimensional image processing
216 compressed image data transmitted from a compressed image memory for three dimensional image processing to an engine for decoding of compressed image data
217 specified voxel image data decoded with an engine for decoding of compressed image data, transmitted from the engine for decoding of compressed image data to an engine for three-dimensional image processing 118.
218 three-dimensional image data
251 displaying of image data from a console or a similar device used to create three dimensional images
252 instruction relating to parameters for processing of three-dimensional images to be used to create three-dimensional images
253 instruction transmitted from an engine for three-dimensional image processing 118 to an engine for an engine for decoding of compressed image data 117, requesting to supply voxel values of the specified voxel coordinates
254 instruction transmitted from an engine for decoding of compressed image data 117 to compressed image memory for three-dimensional image processing 116, requesting to supply compressed image data at specified coordinates
411 three dimensional image display device of the prior art
413 magnetic disk for image data storage
415 three dimensional image processing part of the prior art
416 image data memory of the prior art for three-dimensional image processing
418 engine for three dimensional image processing
414 image data transmitted from magnetic disk to image data memory
417 specified voxel image data transmitted from image data memory for three-dimensional image processing 416 to an engine for three dimensional image processing 418
453 instruction transmitted from an engine for three dimensional image processing 418 to image data memory for three dimensional image processing 416, requesting to supply voxel value at specified voxel coordinates
   Solution

This invention proposes a three-dimensional image display device, wherein image data is compressed so as to correspond to the task relating to the capacity of the magnetic hard disk, necessitated by a great increase in medical image data, as well as to the capacity of the memory for processing of three-dimensional images, to the transmission time for transmission to memory used for processing of three-dimensional images from a magnetic disk, so that three-dimensional images are created while sequential partial decoding is applied according to the progress of three-dimensional image processing applied to the compressed image data. In a case when image data is compressed which reversible compression, the data amount can be compressed to ½˜⅓. Because of that, the capacity of the magnetic disk, the time period for transmission from the magnetic hard disk to the memory for processing of three-dimensional images, and the amount of memory necessary for processing of three-dimensional images can be reduced by ⅓˜½. Moreover, sufficiently realistic three-dimensional images can be created not only when image data is compressed with reversible compression, as the amount of necessary memory can be greatly decreased also when irreversible compression is used.

The invention is equipped with a memory for processing of three-dimensional images, an engine for decoding of compressed image data, and an engine for processing of three-dimensional images. The memory for processing of three-dimensional images holds reversibly compressed image data or irreversibly compressed image data containing image data that is used to create three-dimensional images. The engine for decoding of compressed data decodes voxel data having voxel coordinates specified with decoding operations when compressed imaged data has been received from the memory for processing of three-dimensional images, while the engine for processing of three-dimensional images is used for restoration of voxel data having specified voxel coordinates, so that this data is maintained in the engine for processing three-dimensional images equipped with this function. The engine for processing of three-dimensional images is equipped with a function enabling sequential requesting of voxel data used for processing of three-dimensional images with specified voxel coordinates, which is supplied to the decoding engine as compressed image data, and with a function enabling to create sequentially three-dimensional images using the voxel data provided from the compressed data decoding engine. Because image data used when three-dimensional images are created is held in the memory for processing of three-dimensional images as compressed data, three-dimensional images can be created from compressed image data by applying a sequential control to partially developed compressed data according to the requests, which are sequentially generated according to the progress of three-dimensional image processing operations performed by an engine for processing of three-dimensional operations. Because compressed data is used to create three-dimensional images while sequential partial decoding is applied according to the progress of three-dimensional image processing operations applied to compressed image data, three-dimensional image data can be created from compressed image data. Because compressed image data is used to create three-dimensional images while sequential partial decoding is applied according to the progress of three-dimensional image processing operations, compressed image data can be utilized, making it possible to cope with the problem of insufficient magnetic disk capacity, namely of magnetic disks required for an increased amount of data used as medical image data, and the problem of an extended time period for the transmission time period required for transmission from the magnetic disk to the memory for processing of three-dimensional images, as well as the problem represented by the greatly increased requirements placed on the memory for processing of three-dimensional images.

Using three-dimensional images provided partially with a resolution created from compressed image data in the memory for processing of three-dimensional images, the parameters for processing of three-dimensional images are determined, which include items such as the opacity and the color applied to voxel values, voxel value regions, and spatial regions of voxels creating three-dimensional images. Voxel coordinates are specified for a data decoding engine according to the value region of the voxels and according to the spatial regions of the voxels creating three-dimensional images, calculated by using these parameters for processing of three-dimensional images. Because the data decoding engine is equipped with a function enabling creation of three-dimensional images using the created voxel data based on this specification, a three-dimensional image data display device has been realized enabling creation of three-dimensional images from compressed image data.

Effect of the Invention

The present invention is equipped with a memory for processing of three-dimensional images, an engine for decoding of compressed image data, and an engine for processing of three-dimensional images. When three-dimensional images are created while compressed image data is decoded sequentially and partially according to the progress of processing of three-dimensional images containing compressed image data, compressed image data can be handled to resolve the problem of insufficient magnetic disk capacity, caused by the great increase in the amount of medical image data, the problem of an extended time period required for transmission from the magnetic disk to the memory for processing of three-dimensional images, and also the problem of a great increase in the capacity of the memory required for processing of three-dimensional images can be resolved.

Because compressed data is used as image data during three-dimensional data creating operations and held in memory for processing of three-dimensional image processing operations, this made it possible to greatly reduce the amount of data containing image data that is transmitted from the magnetic disk to memory for three-dimensional image processing operations. Moreover, it thus also became possible to shorten the transmission time when image data is transmitted to the memory for processing of three-dimensional images. Because data is held in memory for processing of three-dimensional images as compressed image data, the amount of the image memory required for processing of three-dimensional images of the same image data can be reduced, enabling processing of three-dimensional images containing a great amount of image data with the same image memory capacity.

Furthermore, because compressed image data is developed in sequential parts by an engine decompressing compressed data according to requirements which are issued sequentially according to the progress of three-dimensional image processing operations performed by an engine for processing of three-dimensional images, it is no longer necessary to develop and decode all of the compressed data. Therefore, this makes it possible to shorten the time period required for processing of the decoding operations.

According to this invention, a method is described which enables creation of three-dimensional images directly from compressed image data, while the amount of memory required for image memory, which is necessary to create three-dimensional images, has been reduced. In a case when image data has been compressed with reversible compression, the data can be generally compressed to ½˜⅓.

As was explained above, although memory enabling loading of 512 MB of data is required in order to handle 512×512×1,024 of individual elements of 16-bit data when image data containing 512×512 image elements as image elements of a vertical profile is superimposed with 1,024 pages in the axial direction of the body, assuming that the data amount can be compressed with reversible compression to ⅓ of the data amount, the amount required for image memory can be decreased to 512 MB×(⅓)=170 MB.

Also, when projection data is divided into projection data categories comprising 10 phases with 1/10 heart beat intervals having equal parts applied to one heart beat, considering a case when image data containing 512×512 image elements per one phase is superimposed as image data in 512 pages using image data of 10 phases created with image regeneration, since 256 MB is required to handle 16 bit data corresponding to 512×512×512 individual elements, image memory enabling to load 2.5 GB of data will be required with a segment corresponding to 10 phases. Assuming that compression can be applied to the data amount with reversible compression resulting in ⅓ of the data amount, the amount of memory required for image memory can be reduced to 262 MB/phase (⅓)×10 phases=853 MB.

Although an example was explained here in which reversible compression was applied to image data, three-dimensional images that are sufficiently realistic can be created also in a case when irreversible compression has been used.

When image data, stored in a magnetic disk as reversibly compressed image data or irreversibly compressed image data, is specified as image data to be used to create three-dimensional images, this compressed image data is transmitted as is, without being decoded, to memory for processing of three-dimensional operations. Therefore, since the data amount which is transmitted from the magnetic disk to the memory can be decreased, this makes it possible to shorten the time period required for transmission from the magnetic disk to the image memory.

Because image data used to create three-dimensional images is held in memory for processing of three-dimensional images as reversibly compressed image data, or as irreversibly compressed image data, the amount of memory required for processing of three-dimensional images with the same image data can be reduced. This also makes it possible to perform processing of three-dimensional images containing a great amount of image data with the same memory capacity. Therefore, the memory capacity required for processing of three-dimensional images has been decreased.

A method has been proposed for high-speed processing of three-dimensional images during processing of three-dimensional images using functions such as early ray termination and skipping of zero voxels. According to such methods, processing of voxels which have no influence on three-dimensional images resulting from the processing can be skipped as their influence can be ignored, without applying image processing operations to the target volume data used for processing of three-dimensional images. Since processing of three-dimensional images is not applied to voxels which can be skipped in this manner, the compressed image data does not need to be decoded. Voxels in which processing of three-dimensional images is required normally represent about 3˜15% of the number of voxels in the entire voxel volume. When a sequential control is applied to sequential and partial development of compressed image data according to request which are sequentially generated in accordance with the progress of operations for processing of three-dimensional images by an engine for processing of three-dimensional images, decoding operations are not applied to voxels that can be skipped. Therefore, since decoding and development of all of the compressed data is not necessary, and since it is sufficient when only about 3˜15% of the total volume of voxels is decoded, this makes it possible to alleviate the corresponding requirements placed upon the decoding and processing capability. In addition, the time period required for decoding and processing can be also shortened.

According to this invention, when reversibly compressed image data is held in a magnetic disk, compressed data can be transmitted as is as required to a hardware substrate for processing of three-dimensional images, and because decoding is applied as required to the hardware substrate for processing of three-dimensional images, the transmission speed can be designed with the high-speed design, applied to the transmission from the magnetic disk to the memory for processing of three-dimensional images. Another problem connected with the hardware substrate which is used for processing of three-dimensional images is that a restriction was imposed on the image memory for the hardware substrate for processing of three-dimensional images. Also, this problem can be improved by placing compressed data in the image memory for a hardware substrate for processing of three-dimensional images, so that the restriction is improved with partial decoding which can be also used as required. According to this invention, the invention is equipped with an engine for decoding and processing of compressed data in a hardware substrate for processing of three-dimensional images, so that successive and partial decoding is applied to compressed data according to the requirements of the three-dimensional image processing engine according to the progress of the three-dimensional processing operations. Although volume rendering processing operations can be conducted with volume rendering processing, which is an example of processing of three-dimensional images, while decoding is applied successively with each minimal unit to compressed data in memory used for processing of three-dimensional image, it is not necessary to perform decoding operations in the sub-volume in which volume rendering processing operations have not been performed according to the zero voxel skip processing method, applied to empty or transparent voxels with optimization using the early ray termination method, wherein cumulative calculations can be terminated while these calculation are still in progress.

Therefore, this makes it possible to relax the requirements placed upon the capacity required for the decoding operations. The invention thus enables substantial savings with respect to the image memory that is used for processing of three-dimensional images in a substrate when volume rendering processing operations are conducted. Moreover, this also enables development of a large amount of volume data which would correspond to several multiples with the same image memory capacity.

Embodiments of the Invention

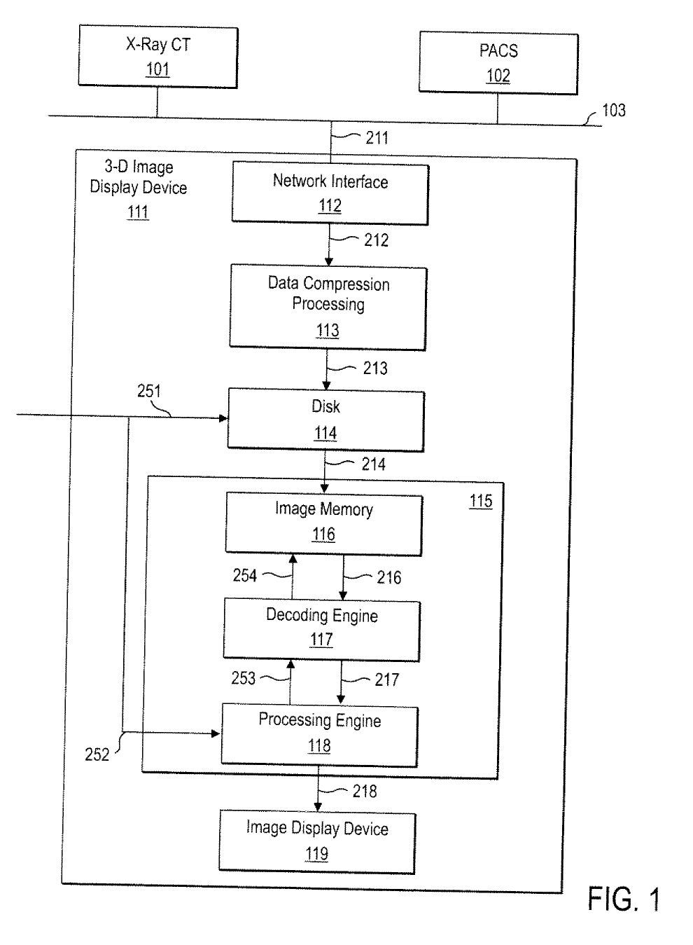

An embodiment of the invention will now be explained. FIG. 1 is a block diagram showing a display device for three-dimensional images used to create three-dimensional images from compressed image data. Reference numeral 101 indicates an example of an image diagnosis device such as an X-ray CT device, MR device, etc. Reference numeral 102 indicates an example of an image data archiving system such as a PACS server. Reference numeral 103 indicates an example of an internal hospital network. Reference numeral 111 indicates a three-dimensional image display device. Reference numeral 112 designates a network interface, enabling to connect to the internal hospital network 103 devices such as the X-ray CT device 101 so that image data 211 can be received from the PACS server 102 or the like, using an X-ray CT device, an MR device, or a similar medical image diagnosis device. The image data 212 is received in some cases as uncompressed image data, and in some cases it can be received as irreversibly compressed or reversibly compressed image data using the JPE 2000 compression method or a similar method.

Reference numeral 113 is an image data compression processing function, wherein compression can be performed with reversible compression such as with JP 2000, or with irreversible compression when image data 212 has not been compressed in order to output compressed image data 213. Reference numeral 114 is a magnetic disk in which compressed image data 213 is stored. Reference numeral 115 is a processing part for processing of three-dimensional images, reference numeral 116 is a memory for compressed images used for processing of three-dimensional data, reference numeral 117 is an engine for decoding of compressed images used for processing of three-dimensional images, and reference numeral 118 is an engine for processing of three-dimensional images.

The image memory 116 for compressed images used for processing of three-dimensional images holds compressed images containing image data which is used to create three-dimensional images.

Reference numeral 251 indicates an instruction obtained from a console or the like, specifying image data to be used in order to created three-dimensional images. Compressed image data 214 is read from the magnetic disk 114 according to this instruction and held in the compressed image memory 116 for processing of three-dimensional images.

Reference numeral 252 indicates an instruction obtained from a console or the like relating to image processing parameters for processing of three-dimensional images used in order to create three-dimensional data.

When the engine 118 for processing of three-dimensional images obtains DICOM information for image data to be read from the compressed image memory 116 for processing of three-dimensional images, operations creating a three-dimensional image are started based on parameters 252, etc., for processing of three-dimensional images when the parameters are obtained.

The processing flow will be explained next.

(1) When image data used in order to create a three-dimensional image is specified from a console or the like according to the instruction 251, the three-dimensional display device reads compressed image data 214 from the magnetic disk 114 and the data is held in the compressed image memory 116 for processing of three-dimensional images.

(2) The engine 118 for processing of three-dimensional images starts processing of three-dimensional images in order to create specified three-dimensional images based on the obtained parameters, such as DICOM information and the like, relating to image data read from the memory 116 for compressed images used for processing of three-dimensional images with the instruction 252, relating to parameters for processing of three-dimensional images obtained from a console or the like.

(3) The engine 118 for processing of three-dimensional images furnishes voxel data used for processing of three-dimensional images with specified voxel coordinates and sends a request 253 to the engine 117 for decoding of compressed image data.

(4) The engine 117 for decoding of compressed image data calculates the voxel data of the voxel coordinates specified by the engine 118 for processing of three-dimensional images in order to restore the voxel data from the compressed data, and the position in which the compressed data is present in the compression memory 116 is calculated using this restoration, while a request 254 is sent to the memory 116 for compressed images used for processing of three-dimensional images to furnish the compressed image data in the positions determined with these calculations.

(5) The memory 116 for compressed images used for processing of three-dimensional images furnishes compressed data 216 in the required position requested by the engine 117 for decoding of compressed data so that the data is furnished to the engine 117 for decoding of compressed image data.

(6) The engine 117 for decoding of compressed image data supplies voxel data 217 with voxel coordinates specified by the engine 118 for processing of three-dimensional images, restored (decompressed) according to decoding processing applied to compressed data 216 provided from the memory 116 for compressed images used for processing of three-dimensional images.

(7) The engine 118 for processing of three-dimensional images executes processing of three-dimensional images using voxel data 217 supplied by the engine 117 for decoding of compressed data.

(8) The engine 118 for processing of three-dimensional images requests the pixel coordinates of the pixels required next and the sequence of the processing operations described in (3)˜(7) is repeated.

The ray casting method will now be explained in one example of processing of three-dimensional images. According to the ray casting method, the viewpoint and three-dimensional volume created with the construction of three-dimensional voxels are taken into consideration together with a two dimensional projection plane placed in the intermediate part between the viewpoint and the three-dimensional volume, creating rays extended toward a two dimensional plane from the viewpoint, so that the values representing the product of the opacity and the voxel values of the voxel on a ray are sequentially calculated in the voxels making up the structure of the three-dimensional volume to create the values of a two dimensional projection plane and of its image elements intersected by rays.

When the product of the luminescence value and of the opacity of respective voxels is calculated with the ray casting method, the sum total of 1 is created for the opacity, and when the rays are subtracted from the volume representing the target, processing relating to these rays is finished and the value of image elements intersected by the ranges of the two dimensional projection plane resulting from the calculations is displayed. Because the calculation is terminated at the point in time when the integral value of the opacity obtained with such a ray casting method is 1, the value of voxels after this coordinated is not clear. Accordingly, in the case of the present invention, it is not necessary to apply decoding to compressed data.

The engine 118 for processing of three-dimensional images requests 253 from engine 117 decoding of compressed image data sent with the voxel values of the voxel data having the voxel coordinates determined as voxel coordinates of voxels that are needed in order to created three-dimensional images.

To perform restoration of voxel data having voxel coordinates specified by the engine 118 for processing of three-dimensional images the from compressed data, the engine 117 for decoding of compressed image data calculates the present position in the compressed image memory for three dimensional image processing 116 of a block of compressed image data used for restoration from the compressed image data of voxel data having specified voxel coordinates, and a block of this compressed data is requested 254 from the memory 116 for compressed images used for processing of three-dimensional images.

The memory 116 for compressed images used for processing of three-dimensional images sends a block of compressed data 216 in the requested position to the engine 117 for decoding of compressed image data.

The block of the compressed image data 216, restored by the decoding operations of the engine 117 for decoding of compressed images, is supplied with the voxel data 217 having the specified voxel coordinates to engine 119 for three-dimensional image processing operations.

If the integral value of opacity created at this point in time is less than 1, the coordinates of the next voxel for this ray are specified and the voxel value is supplied with a request sent to the engine 117 for decoding of compressed image data, so that the processing operations will be repeated until the integral value of 1 is reached for opacity.

If the integral value of 1 has been reached for opacity, the processing related to this ray is finished at this point in time and the processing of the next ray is begun.

During customary ray casting processing operations, rays are specified by a three-dimensional processing engine, the voxel coordinates for these rays are successively specified and the voxel values having these voxel coordinates are acquired from the image data in the memory.

According to the ray casting processing of this invention, the rays are specified with an engine for processing of three-dimensional images, and furnishing of the voxel values having the voxel coordinates is requested 253 from engine 117 for decoding of compressed image data.

The engine 117 for decoding of compressed image data calculates the block position of compressed data used for restoration from the compressed image data containing voxel data having the specified voxel coordinate for restoration of voxel data with the voxel coordinate specified by the engine 118 for processing of three-dimensional images, so that the block of compressed image data in this position is requested 254 from the memory 116 for compressed images used for processing of three-dimensional images.

The memory 116 for compressed images for processing of three-dimensional images sends the compressed image data 216 that has been requested to the engine 117 for decoding of compressed data.

The engine 117 for decoding of compressed image data furnishes the voxel data 217, having the specified coordinates after the restoration of decoding processing applied to this block of compressed data 216, as voxel data having the specified voxel coordinates to the engine for processing of three-dimensional images.

In this case, the fact that an engine 117 is created for decoding of compressed image data is a special characteristic of this invention. According to this invention, when compressed data present in the memory is acquired by image 117 for decoding of compressed image data, decoding processing is applied to this data so that restored data is then sent to an engine for processing of three-dimensional images. Because of that, an engine for processing of three-dimensional images can use image data stored in image memory, regardless of whether this data is stored as compressed data or as uncompressed data, so that processing of three-dimensional images can be realized.

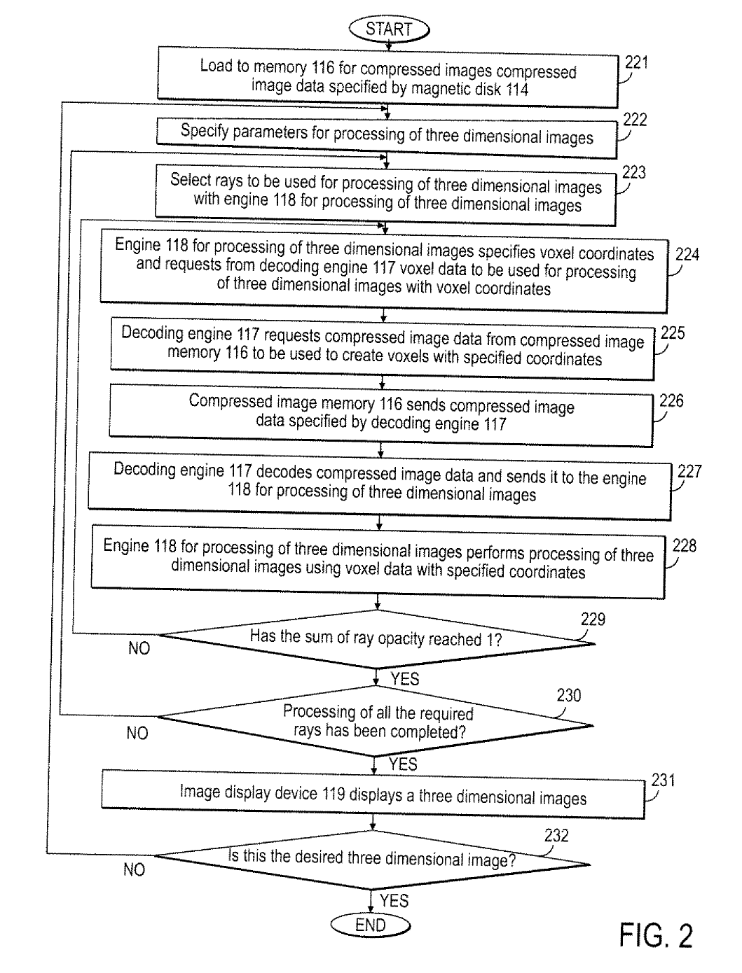

FIG. 2 is a flowchart explaining the present embodiment. At step 221 magnetic disk 114 loads specified compressed image data 214 to the compressed image memory 116 for three dimensional image processing. At step 222 the parameters for processing of three-dimensional images are specified. At step 223 engine 118 for processing of three-dimensional images selects rays to be used for processing of three-dimensional images. At step 224 the engine 118 for processing of three-dimensional images sends a request 253 for voxel data 217 to be used for processing of three-dimensional images, wherein the voxel coordinates are specified for the decoding engine 117. At step 225 decoding engine 117 sends a request 254 for a block of compressed data 216 from the compressed image memory for three dimensional image processing 116 to be used in order to create voxel data having the specified coordinates. At step 226 the memory 116 for compressed images sends the specified compressed image data 216 to the decoding engine 117. At step 227 compressed image data 216 is decoded by the decoding engine 117 and specified voxel data 217 is sent to the engine 118 for processing of three-dimensional images. At step 228 the engine 118 for processing of three-dimensional images performs processing of three-dimensional images using voxel data 217 having the specified coordinates. At step 229 the processing operations described in 224 through 209 are repeated until the sum of the opacity for the rays reaches 1. At step 230 the operations described in 223 through 228 are repeated until the processing relating to all the required rays has been completed. At step 231 image display device 119 displays a three-dimensional image. At step 232 if the desired three-dimensional image has not been obtained, the processing operations described in 222 through 231 are repeated.

The engine 118 for processing of three-dimensional images specifies for the decoding engine 117 the voxel coordinates of the voxels to be used for processing of three-dimensional images and requests voxel data to be used for processing of three-dimensional images with the specified voxel data.

The decoding engine 117 calculates the position in which the compressed image data that is required to create voxel data with the specified coordinates is stored in the memory and requests compressed image data from the compressed image memory 116.

In this case, the decoding engine 117 can also request from the compressed image memory for three dimensional image processing 116 a block of compressed image data that is required to created voxel data with specified coordinates. In such a case, when the decoding engine 117 decodes (decompresses) the block of compressed data supplied from the memory 116 for compressed images, and restores decompressed image data as the specified image data furnished to the engine 118 for processing of three-dimensional images, while the unused image data is temporarily stored so that thereafter, this data is used when a request is sent from the three-dimensional image processing engine 118 for ray casting with rays in the vicinity. Specifically, when image data is present that has been already decoded by the decoding engine 117 as data requested by the image 118 for processing of three-dimensional images, compressed image data will not be requested from the compressed image memory 116 for processing of compressed images and the stored data will be sent to the image 118 for processing of three-dimensional images.

When JPEG 2000 is used, the discrete wavelet transformation factor is analyzed on the bit plane so that after a block encoded in each sub-band for example as 64×64 has been divided, binary encoding can be employed. Random access to specific regions can be easily created by applying an independent encoding system with encoded block units. Therefore, in the present embodiment, compressed data which has been compressed with irreversible or reversible JPEG2000 compression can be used together with an engine for decoding of compressed image data of this invention, enabling a simple realization.

### Embodiment 1

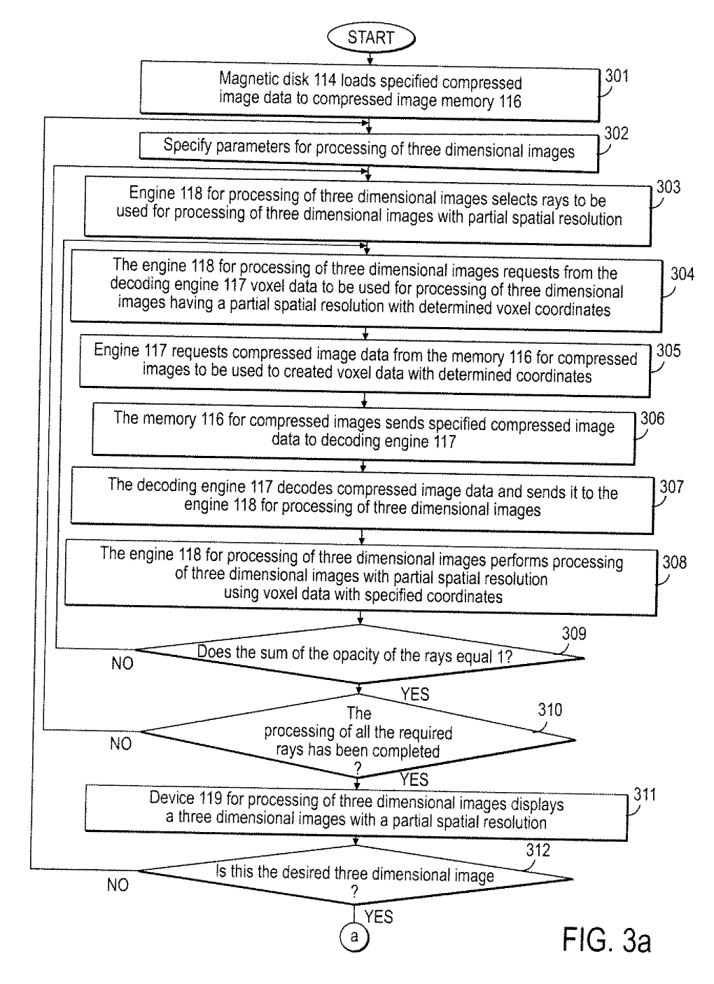

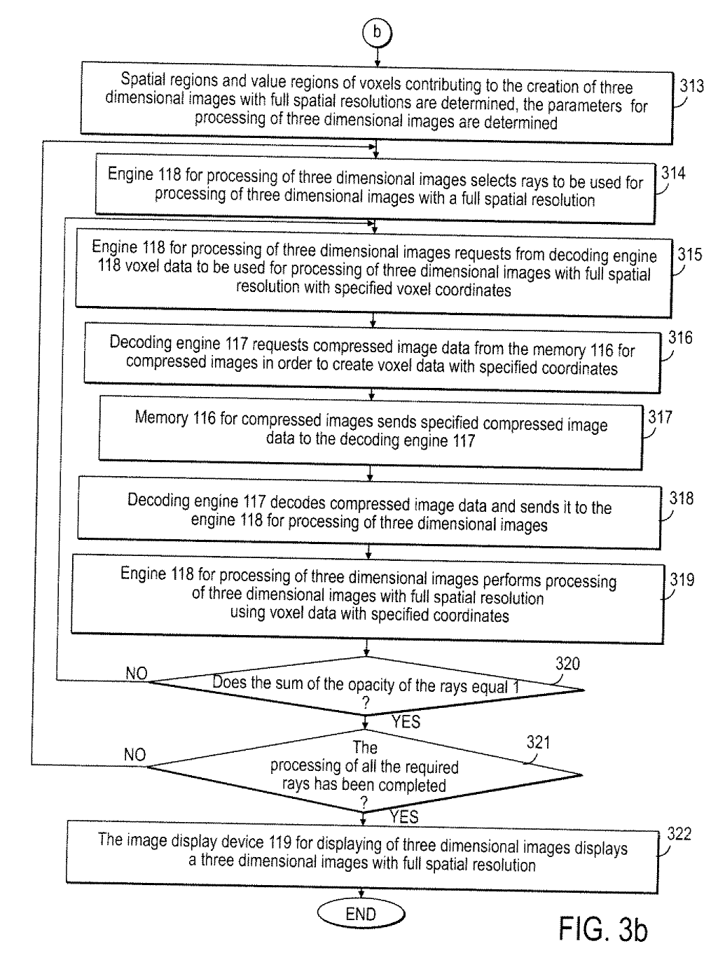

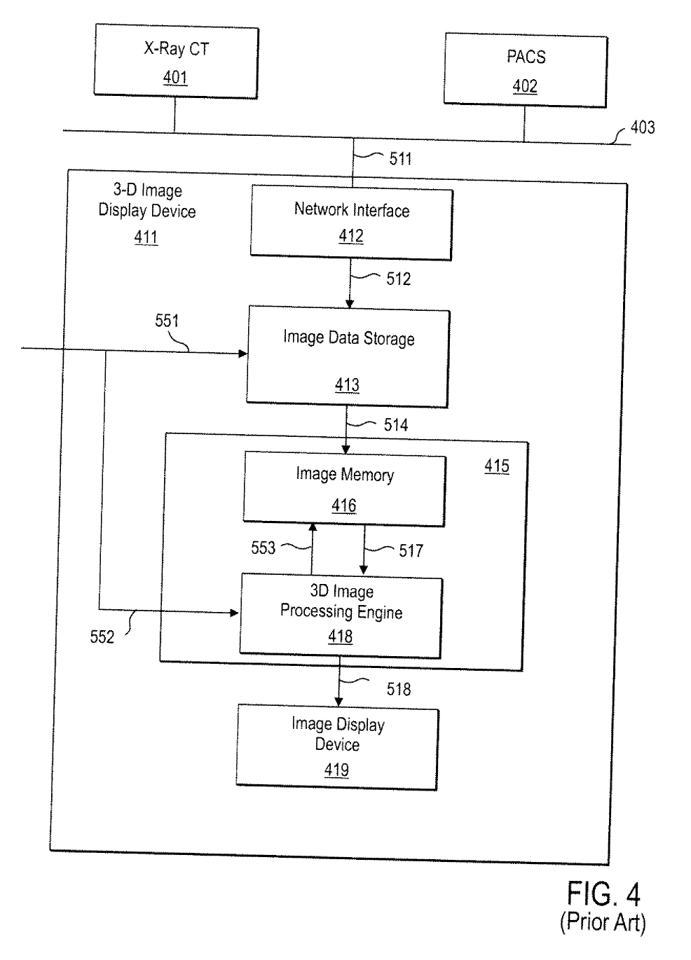

FIG. 3 shows a flowchart explaining another embodiment of this invention. In this embodiment, three-dimensional images are formed in the initial first step with partial spatial resolution. On the other hand, because the images are displayed while the parameters for processing of three-dimensional images are changed, optimal parameters can be determined for processing of three-dimensional images. During the next step, three-dimensional images are created with complete spatial resolution applied with the parameters for processing of three-dimensional images that were determined in the first step. Because optimal parameters for processing of three-dimensional images are determined in this manner with three-dimensional images having a partial spatial resolution, this makes it possible to alleviate the stress placed on the processing of three-dimensional images, when three-dimensional images are created with complete spatial resolution using suitable parameters for processing of three-dimensional images.

When for example compressed data is used with JPEG2000 using 1,024 image pages with 512×512 image elements, since data corresponding to 512 image pages with 256×256 image elements or to 256 pages of mages with 128×128 image elements can be easily obtained, three-dimensional images can be created with a partial spatial resolution with these operations.

Referring now to FIG. 3, at step 301, magnetic disk 114 loads specified compressed image data to the compressed image memory for three dimensional image processing 116. At step 302 parameters for processing of three-dimensional images are specified. At step 303 engine 118 for processing of three-dimensional images selects ray to be used for processing of three-dimensional images with a partial spatial resolution. At step 304 the engine 118 for processing of three-dimensional images requests voxel data to be used for processing of three-dimensional images with specified voxel parameters for voxels to be used for processing of three-dimensional images with partial spatial resolution for decoding engine 117. At step 305 the engine 117 requests compressed image data from the compressed image memory 116 for generating voxel data at specified voxel coordinates. At step 306 the compressed image memory 116 sends the specified compressed image data to the decoding engine 117. At step 307 the decoding engine 117 decodes (decompresses) the compressed data and sends it to the engine 118 for processing of three-dimensional images. At step 308 the engine 118 for processing of three-dimensional images processes three-dimensional images having a partial spatial resolution using voxel data with the specified coordinates. At step 309 the processing operations conducted in 304 through 308 are repeated until the sum of opacity for the layers equals 1. At step 310 the processing operations conducted in 303 through 308 are repeated until the processing relating to all the required rays has been completed. At step 311 image display device 119 displays a three-dimensional image with a partial spatial resolution. At step 312 if the desired three-dimensional image has not been obtained, the processing operations conducted in 302 through 311 are repeated.

At this point the desired three-dimensional image has been obtained, a three-dimensional image is created with complete spatial resolution. At step 313 voxels are selected for threshold regions and for spatial regions contributing to the creation of three-dimensional images having a full spatial resolution based on the three-dimensional image which has a partial spatial resolution and the parameters for processing of three-dimensional images are determined. At step 314 the engine 118 for processing of three-dimensional images selects rays to be used for processing of three-dimensional images with full spatial resolution. At step 315 engine 118 for processing of three-dimensional images specifies voxel coordinates of the voxels to be used for processing of three-dimensional images with full spatial resolution from the decoding engine 117 and requests voxel data to be used for processing of three-dimensional images. At step 316 decoding engine 117 requests compressed image data from the compressed image memory 116 to be used to create voxel data with specified coordinates.

At step 317 compressed image memory 116 sends the specified compressed image data to the decoding engine 117. At step 318 decoding engine 117 decodes compressed image data and sends it to the engine 118 for processing of three-dimensional images. At step 319 engine 118 for processing of three-dimensional images performs processing of three-dimensional images with full spatial resolution using voxel data having the specified coordinates.

At step 320 the operations conducted in 315 through 319 are repeated until the opacity created for the rays reaches 1. At step 321 the operations conducted in 314 through 320 are repeated until the processing related to all required rays is finished. Finally, at step 322 image display device 119 displays a three-dimensional image with a full spatial resolution.

In the case when JPEG 2000 was used for compression of image data, for example by applying compression to image data with 512×512 image elements, the operation can be performed using sub-block units with 64×64 image elements. When the data was compressed with JPEG 2000 applied to 1,024 pages of image element data, it was possible to obtain easily data corresponding to 512 image element pages with 256×256 image, or data corresponding to 256 image element pages with 128×128 image elements. Accordingly, this embodiment can be easily realized with a decoding engine and compressed image data according to this invention, either as compressed image data which has been compressed with the JPEG 2000 reversible compression or with the irreversible compression method.

### Embodiment 2

Another embodiment of this invention will be explained next. While the explanation up until now pertained to a case of a three-dimensional image display wherein both a data decoding engine 117 and an engine 118 for processing of three-dimensional images were implemented purely as hardware, the three-dimensional display image of this invention also includes cases in which the data decoding engine 117 is implemented as hardware according to this invention, but the three-dimensional processing engine 118 is implemented at least partially as software, as well as cases in which both the data decoding engine 117 and the three-dimensional processing engine 118 are implemented at least partially as software.

Although special hardware is presently contemplated to display three-dimensional images within a time period that does not create the feeling of stress, it is also possible to realize a sufficiently practical display device for displaying of three-dimensional images when the software design is applied to the data decoding engine 117 and to the three-dimensional image processing engine 118 using a common type of computer or a common type of computer with increased computational speed.

And while it was explained up until now that the engine 117 for decoding of compressed image data was created as an engine that was separate from the engine 118 for processing of three-dimensional images, an integrated hardware or software design including both of these functions can be also implemented.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method of three-dimensional image processing, the method comprising:
storing a set of encoded image data in a memory, the image data usable for creating three-dimensional images;
identifying and decoding portions of the set of encoded image data stored in the memory based on requests sequentially issued by an image processing engine according to a progress of image processing; and
providing the decoded portions of the set of encoded image data to the image processing engine.

2. A method as recited in claim 1, wherein the set of encoded image data stored in the memory comprises compressed image data, and wherein said decoding portions of the set of encoded image data stored in the memory comprises decompressing said portions of the set of encoded image data stored in the memory.

3. A method as recited in claim 1, wherein the set of compressed image data corresponds to a set of voxels, and wherein decoding portions of the set of compressed image data comprises:
skipping decoding of data corresponding to voxels that have no influence on three-dimensional images resulting from said processing.

4. A method as recited in claim 32, wherein said voxels that have no influence on three-dimensional images resulting from said processing comprise empty or transparent voxels.

5. A method as recited in claim 1, wherein said image processing comprises volume rendering.

6. A method as recited in claim 1, further comprising determining parameters for three-dimensional image processing, including opacity and color applied to voxel values, voxel value regions, and spatial regions of voxels used to create three-dimensional images, to create three-dimensional images with a partial resolution from compressed image data stored in the memory.

7. A method as recited in claim 6, wherein decoding portions of the set of compressed image data is in response to instructions containing voxel coordinates of value regions of voxels and of special regions of voxels.

8. A method as recited in claim 1, wherein the image data is a set of related data generated by a scanning device.

9. A method as recited in claim 8, wherein the image data is a set of related data generated by a medical scanning device and relating to a particular target object of a scan.

10. A method of three-dimensional image processing, the method comprising:
storing a set of compressed image data in a memory;
receiving parameters for three-dimensional image processing;
determining a set of voxel coordinates corresponding to a portion of the set of compressed image data;
locating the portion of the set of compressed image data in the memory based on the voxel coordinates;
retrieving the portion of the set of compressed image data from the memory;
decompressing the portion of the set of compressed image data to produce voxel data corresponding to the specified voxel coordinates; and
providing the decompressed data to a processing engine for three-dimensional image processing.

11. A method as recited in claim 10, wherein said image processing comprises volume rendering.

12. A method as recited in claim 10, wherein determining a set of voxel coordinates comprises:
determining the set of voxel coordinates according to a progress of image processing by an image processing engine.

13. A method as recited in claim 10, wherein the image data is a set of related data generated by a scanning device.

14. A method as recited in claim 13, wherein the image data is a set of related data generated by a medical scanning device and relating to a particular target object of a scan.

15. A three-dimensional image processing device comprising:
a memory to store a set of compressed image data usable to create three-dimensional images;
a processing engine to perform three-dimensional image processing, and further to specify coordinates of voxels to be used for three-dimensional image processing; and
a decoding engine to calculate a position in which encoded image data that is required to create voxel data corresponding to the specified coordinates is stored in the memory, to obtain from the memory encoded image data based on the specified voxel coordinates, and to restore and provide to the processing engine voxel data corresponding to the specified coordinates, including to decode portions of the set of encoded image data stored in the memory according to requests sequentially issued by the processing engine based on a progress of three-dimensional image processing.

16. A three-dimensional image processing device as recited in claim 15, wherein said encoded image data comprises compressed image data, and wherein to decode portions of the set of encoded image data stored in the memory comprises to decompress said portions of the set of encoded image data stored in the memory.

17. A three-dimensional image processing device as recited in claim 15, wherein to decode portions of the set of compressed image data stored in the memory comprises:
to skip decoding of data corresponding to voxels that have no influence on three-dimensional images resulting from said processing.

18. A three-dimensional image processing device as recited in claim 17, wherein said voxels that have no influence on three-dimensional images resulting from said processing comprise empty or transparent voxels.

19. A three-dimensional image processing device as recited in claim 15, wherein said processing of the three-dimensional images comprises volume rendering.

20. A three-dimensional image processing device as recited in claim 15, wherein parameters are determined for processing of the three-dimensional images, including opacity and color applied to voxel values, voxel value regions, and spatial regions of voxels used to create three-dimensional images, to create three-dimensional images with a partial resolution from compressed image data stored in the memory.

21. A three-dimensional image processing device as recited in claim 20,
wherein the decoding engine is provided with instructions containing voxel coordinates of value regions of voxels and of special regions of voxels; and
further comprising means for enabling creation of three-dimensional images using the voxel data created by the decoding engine based on the instructions.

22. A three-dimensional image processing device as recited in claim 15, wherein the three-dimensional image processing device is implemented in a hardware substrate for processing three-dimensional images.

23. A three-dimensional image processing device as recited in claim 15, wherein both the decoding engine and the processing engine are implemented purely as hardware.

24. A three-dimensional image processing device as recited in claim 15, wherein the decoding engine is implemented purely as hardware, and the processing engine is implemented at least partially as software.

25. A three-dimensional image processing device as recited in claim 15, wherein both the decoding engine and the processing engine are implemented at least partially as software.

26. A three-dimensional image processing device as recited in claim 15, wherein the image data is a set of related data generated by a scanning device.

27. A three-dimensional image processing device as recited in claim 26, wherein the image data is a set of related data generated by a medical scanning device and relating to a particular target object of a scan.
